(19) United States
(12) Patent Application Publication
(10) Pub. No.: US 2009/0038261 A1
(43) Pub. Date: Feb. 12, 2009

(54) FIRE DOOR AND MANUFACTURING METHOD THEREOF

(75) Inventors: Hae-sik Lee, Gwangju (KR); Bong-jun Lee, Gwangju (KR)

Correspondence Address: QUINN LAW GROUP, PLLC, 39555 ORCHARD HILL PLACE, SUITE # 520, NOVI, MI, 48375, US

(73) Assignees: MATERIAL SCIENCES CORPORATION, Elk Grove Village, IL (US); HAEWON MSC. CO., LTD, Jeollanam-do (KR)

(21) Appl. No.: 12/188,455

(22) Filed: Aug. 8, 2008

(30) Foreign Application Priority Data
Aug. 9, 2007 (KR) 10-2007-0080075

(51) Int. Cl. E06B 5/16; B29C 65/48; B29C 65/72; B29C 65/74

(52) U.S. Cl. 52/784.11; 156/212; 156/79

(57) ABSTRACT

A fire door includes an inner plate forming an inner side of the fire door; an outer plate opposing the inner plate to form an outer side of the fire door; adhesive layers applied to opposing surfaces of the inner and outer plates; a pair of reinforcing brackets vertically attached to opposite edge portions between both of the inner and outer plates; and a sound absorbing material filled in a space defined by the inner and outer plates and the reinforcing brackets. The inner and outer plates are made of a bonded steel plate, which includes a surface sheet exposed to the inner or outer side of the fire door, a backing sheet supporting the surface sheet, and an adhesive material interposed between the surface sheet and the backing sheet and bonding the surface sheet and the backing sheet together. The fire door has excellent sound absorbing and fireproof properties.

### CROSS-REFERENCE TO RELATED APPLICATIONS

This application claims priority to Korean Application 10-2007-0080075, filed on Aug. 9, 2007.

### BACKGROUND OF THE INVENTION

The present invention relates to a fire door and a manufacturing method thereof, and more particularly, in which bonded steel plates having intrinsic sound-absorbing performance and reduced costs and are used for inner and outer plates of the fire door in order to damp external noise thereby ensuring quietness inside a room while obtaining heat-insulating effect, ensure fine aesthetic appearance and fireproof performance that are equal to those of conventional fire doors, and remarkably reduce manufacturing cost.

### DESCRIPTION OF THE RELATED ART

At present, the use of the fire door is forced by relevant laws in some jurisdictions. Since the fire door is provided for the purpose of a fireproof function, it is basically made of steel. However, the fire door made of steel is not good for indoor use since it has a cold feeling and undesirable appearance. Hence, the steel fire door is typically used only in places where it is mandatory to be installed. For doors arranged inside a house, wood is mainly used to provide a natural and desirable appearance, however, wood is vulnerable to fire.

Accordingly, various approaches have been sought in order to use the steel door, which has drawbacks of having a cold feeling and undesirable appearance in spite of the merit of being fireproof, as interior doors. For example, inner and outer sheets made of steel are processed to make a door have various shapes via banding or pressing, and the outer surfaces of the steel door are decorated with various colors via finishing with powder painting or interior films in order to improve the cold feeling and undesirable appearance of the steel door.

Recently, expensive materials such as stainless steel and aluminum, which give fine aesthetic appearance, are replacing steel materials. A door made of such a material gives surface beauty owing to the intrinsic properties of the material, which can be further improved by surface treatment. Therefore, the use of this kind of door can produce various smooth indoor and outdoor appearances, thereby further enhancing the value of a building where the door is used.

However, in spite of such advantages, the use of these materials such as stainless steel, copper and titanium is limited to high-class buildings due to the high price thereof. Although these materials provide good external appearances, these materials themselves are deficient in sound-absorbing and vibration-damping properties, and thus should be bonded with a separate sound and vibration damping member. That is, although the use of the expensive materials can improve the aesthetic appearance of the door, some drawbacks in terms of price competitiveness and sound-absorbing properties are apparent.

### SUMMARY OF THE INVENTION

The inventors have recognized the recent trend that the outer appearance of houses are being regarded more important and consumers also prefer a house that gives cozy and high class appearance but is inexpensive. For this reason, the inventors have developed a novel fire door, which has sufficient price competitiveness and improved beauty and sound-absorbing properties compared to conventional articles, and a manufacturing method thereof.

The invention provides the fire door by preparing inner and outer plates with a bonded steel plate, which is inexpensive, gives an excellent outer appearance, and has excellent sound-absorbing property. More particularly, the inner and outer plates are prepared by carrying out surface treatment or powder painting to surface sheets, which are exposed to the outside, to give an excellent outer appearance to the surface sheet, preparing backing sheets, which are not exposed to the outside, using an inexpensive material, and bonding the surface and backing sheets together using an adhesive having excellent sound-absorbing property.

The present invention provides a fire door, in which each of inner and outer plates is made of a bonded steel plate consisting of surface and backing sheets bonded together by an adhesive layer in order to obtain a sound-absorbing function from the adhesive layer of the bonded steel plate, and which remarkably reduces manufacturing cost, ensures fine aesthetic appearance and fireproof performance equal to those of conventional fire doors, and achieves excellent noise-isolating and sound-absorbing effects.

The present invention also provides a fire door, in which an adhesive layer of bonded steel plates is adapted to maintain proper viscosity, so that the adhesive layer is not fractured when inner and outer plates are manufactured by bending the bonded steel plates and in which the viscosity of the adhesive layer enhances a sound-absorbing property.

The present invention also provides a fire door, in which a thinner surface sheet, exposed to the outside of the fire door, is formed using a steel sheet having excellent aesthetic appearance and processability, a thicker backing sheet, arranged inside to support the surface sheet, and is formed using a relatively less expensive steel plate, and in which the surface and backing sheets are bonded together using an adhesive excellent in sound-absorbing property in order to remarkably reduce the manufacturing cost, so that the problem of increased manufacturing cost due to the use of a single steel plate, made of a relatively expensive material such as copper and aluminum, can be overcome.

The present invention also provides a fire door, which can prevent casualties caused by gases produced from burning adhesive at the outbreak of fire, by adopting a composition, which does not produce toxic gases when the adhesive for bonding the surface and backing sheets is burned.

The present invention also provides a fire door, which can be variously applied, particularly, to a front door or an outside equipment door, which is generally made of iron or steel in the prior art, and also to a bedroom door by finishing surface sheets, having an excellent decoration feature, with powder painting or interior films in order to replace woody interior doors that are very vulnerable to fire.

And yet the present invention also provides a fire door of reduced weight by manufacturing the backing sheets, which are not exposed to the outside, with an inexpensive and light material. In particular, the door of the present invention is a bedroom door and so on, which is easily opened and closed.

According to an aspect of the invention, there is provided a fire door including an inner plate forming an inner side of the fire door; an outer plate opposing the inner plate to form an outer side of the fire door; adhesive layers applied to opposing surfaces of the inner and outer plates; a pair of reinforcing brackets vertically attached to opposite edge portions between both of the inner and outer plates; and a sound absorbing material filled in a space defined by the inner and outer plates and the reinforcing brackets. Each of the inner and outer plates comprises a bonded steel plate, which includes a surface sheet exposed to the inner or outer side of the fire door, a backing sheet supporting the surface sheet, and an adhesive material interposed between the surface sheet and the backing sheet and bonding the surface sheet and the backing sheet together, whereby the fire door has excellent sound absorbing and fireproof properties.

Preferably, the adhesive layers comprise foamed urethane, and the sound absorbing material comprises a honeycomb core or a urethane foam.

More preferably, each of the adhesive materials has a thickness ranging from 0.02 mm to 0.1 mm.

Further more preferably, each of the surface sheets has a thickness ranging from 0.1 mm to 0.5 mm, and each of the backing sheets has a thickness ranging from 0.5 mm to 1.9 mm.

According to an embodiment of the present invention, each of the surface sheets 10a and 20a and the backing sheets has a bending rigidity ranging from 10.5 Nm to 16.5 Nm.

Preferably, the adhesive materials have a viscosity ranging from 2500 cps to 4500 cps.

More preferably, the adhesive materials comprise 44% to 46% by weight of ethyl acetate, 40% to 42% by weight of vinyl acetate/acryl copolymer, 8% to 10% by weight of isopropyl alcohol, 1% to 3% by weight of toluene, up to 3% by weight of vinyl acetate and up to 0.1% by weight of acetaldehyde.

Further more preferably, the surface sheets comprise one selected from a group consisting of stainless steel, aluminum and copper, which are excellent in surface treatment and surface processing, and wherein the backing sheets comprise one selected from a group consisting of a zinc-coated steel sheet, a stainless steel sheet, an aluminum sheet, a pre-painted steel sheet, a cold-rolled steel sheet and a pickled and oiled steel sheet.

According to another aspect of the invention, there is provided a method of manufacturing a fire door. The method includes steps of preparing a bonded steel plate which includes a surface sheet to be exposed to the inner or outer side of a door, a backing sheet supporting the surface sheet, and an adhesive layer interposed between the surface sheet and the backing sheet to bond the surface sheet and the backing sheet together, punching the bonded steel plate so that hinges and a lock device can be mounted thereon, shaping the punched bonded steel plate into an inner plate and an outer plate, which form the inner and outer sides of the door, applying an adhesive material to opposing inner surfaces of the inner and outer plates, attaching a pair of reinforcing brackets to opposite edge portions between the inner and outer plates along the vertical direction of the door and filling a sound-absorbing material in a space defined by the inner and outer plates and the reinforcing brackets, activating the adhesive material using a hot press machine to enhance the bonding force of the reinforcing brackets and the sound-absorbing material arranged between the inner and outer plates, and bending outer vertical peripheries of the inner and outer plates into the shape of the door and attaching the hinges and the lock device to holes formed in the inner and outer plates via the punching.

### BRIEF DESCRIPTION OF THE DRAWINGS

The above features and other features and advantages of the present invention will be more clearly understood from the following detailed description taken in conjunction with the accompanying drawings, in which:

FIG. 1 is a cross sectional view illustrating the structure of a fire door according to an embodiment of the present invention;

FIG. 2 is a cross sectional view illustrating the fire door according to the embodiment of the present invention, mounted on a door frame;

FIG. 3 is a perspective view illustrating the fire door according to the embodiment of the present invention; and

FIG. 4 is a flowchart illustrating a method of manufacturing the fire door according to an embodiment of the present invention.

### DETAILED DESCRIPTION OF THE PREFERRED EMBODIMENT

The fire door of the present invention will now be described more fully with reference to the accompanying drawings, in which preferred embodiments thereof are shown.

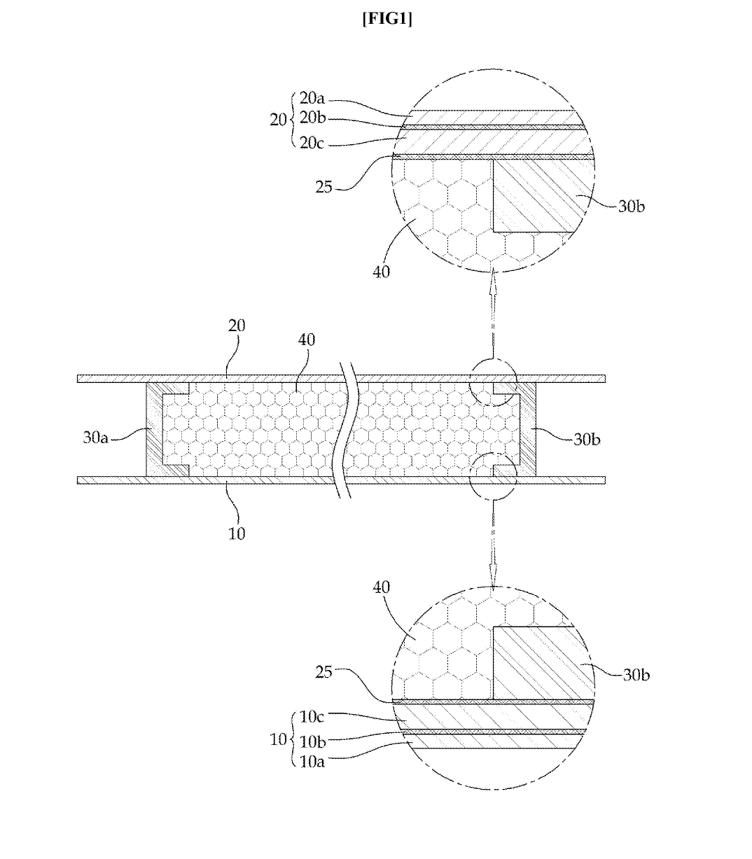

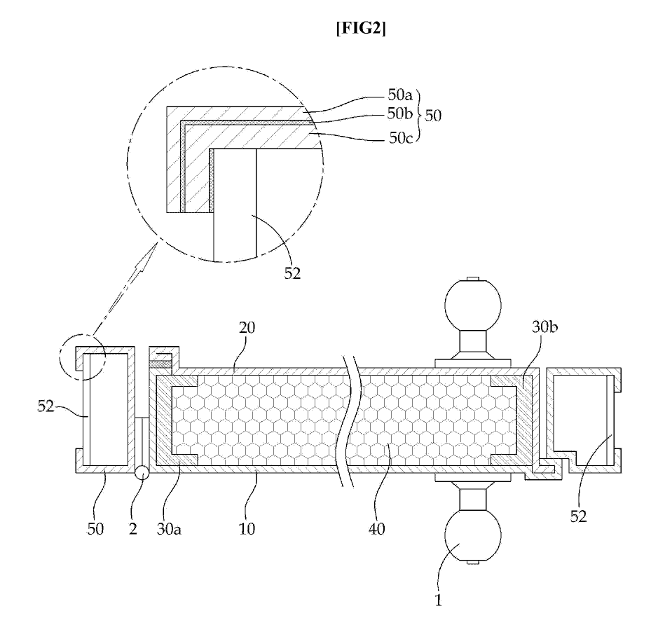

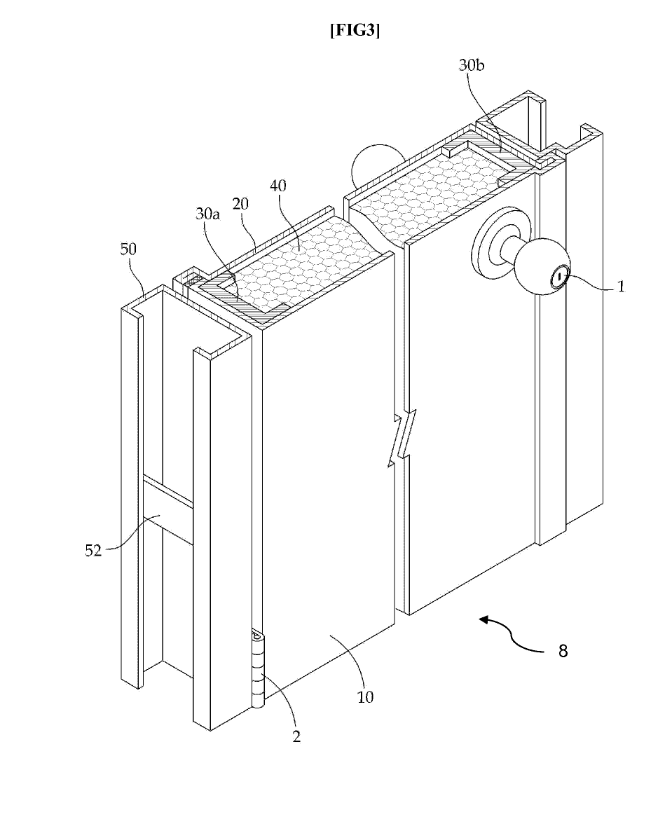

FIG. 1 is a cross sectional view illustrating the structure of a fire door according to an embodiment of the present invention, FIG. 2 is a cross sectional view illustrating the fire door according to the embodiment of the present invention, mounted on a door frame, and FIG. 3 is a perspective view illustrating the fire door according to the embodiment of the present invention.

With reference to FIG. 1 the fire door 8 of this embodiment has excellent sound absorbing and fireproof properties, and includes an inner plate 10 forming an inner side of the fire door, an outer plate 20 opposing the inner plate 10 to form an outer side of the fire door, adhesive layers 25 applied to opposing surfaces of the inner and outer plates 10 and 20 respectively, a pair of reinforcing brackets 30a and 30b vertically attached to vertical edge portions of both of the inner and outer plates 10 and 20, and a sound absorbing material 40 filled in an area defined by the inner and outer plates 10 and 20 and the reinforcing brackets 30a and 30b.

As shown in FIG. 1, the inner plate 10 is a bonded steel plate, which includes a surface sheet 10a, exposed on top of the inner side of the fire door, a backing sheet 10c supporting the surface sheet 10a and an adhesive material 10b (e.g., adhesive resin) interposed between the surface sheet 10a and the backing sheet 10c to bond the surface sheet 10a and the backing sheet 10c together. The outer plate 20 is also a bonded steel plate, which includes a surface sheet 20a, exposed on top of the outer side of the fire door, a backing sheet 20c supporting the surface sheet 20a and an adhesive material 20b interposed between the surface sheet 20a and the backing sheet 20c to bond the surface sheet 20a and the backing sheet 20c together.

Preferably, each of the surface sheets 10a and 20a is one selected from a group consisting of stainless steel, aluminum and copper, which are excellent in surface treatment and surface processability. Each of the backing sheets 10c and 20c is one selected from a group consisting of a zinc-coated steel sheet, a stainless steel sheet, an aluminum sheet, a pre-painted steel sheet, a cold-rolled steel sheet and a pickled and oiled steel sheet. More preferably, the surface sheets 10a and 20a are implemented with a SUS300 series material (most preferably, SUS304), which is excellent in surface processability and corrosion resistance. Since the inner and outer plates of the fire door are produced by performing a simple processing (e.g., pattern pressing, bending and seaming) to the bonded steel plates, they can be implemented with substantially all types of steel. It is preferable that the backing sheets 10c and 20c are selected from preset types of steel, which can sufficiently support the surface sheets. That is, the backing sheets can be any of a zinc-coated steel sheet, a stainless steel sheet, an aluminum sheet, a polyester-painted steel sheet, a cold-rolled steel sheet and a picked and oiled steel sheet. Here, the zinc-coated steel sheet should be understood in a broad sense that embraces a galvanized steel sheet, an electrolyte galvanized steel sheet, a galvannealed steel sheet, an aluminum coated steel sheet, a zinc-aluminum alloy coated steel sheet and so on.

The surface sheets 10a and 20a and the backing sheets 10c and 20c of the bonded steel plate have proper bendability in order to be bent in the shape of the fire door. In order to meet this bendability, the sheets are preferably selected from materials having bending rigidity ranging from 10.5 Nm to 16.5 Nm.

The bending rigidity is calculated using Ross Kerwin Ungar(RKU) method expressed by Equation 1 below:

$$E = \frac{12 ( 1 - {υ}^{2} ) {B}_{c}}{{t}_{c}^{3}} , \qquad Equation 1$$

where B_{c} is the bending rigidity, υ is the Poisson's ratio, and t_{c} is the total thickness.

Particularly, when the bending rigidity is less than 10.5 Nm, the sheet can be warped by weak force, and thus be vulnerable to external impact after shaping. In contrast, when the bending rigidity is more than 16.5 Nm, bendability is reduced and thus the fire door may not be smoothly shaped.

The adhesive material 10b, 20b (e.g., adhesive resin) is interposed between the surface sheet and the backing sheet, and functions to bond the surface and backing sheets together. Preferably, the adhesive material is formed with a thickness ranging from 0.02 mm to 0.1 mm. Because the adhesive material is interposed between the surface sheet and the backing sheet, absorbing sound such as noise, it enables the entire bonded steel plate to produce excellent sound-absorbing effects. In other words, the adhesive material 10b, 20b functions to bond the surface sheet with the backing sheet while absorbing and isolating noise from the outside.

Preferably, the adhesive material used in the present invention has viscosity ranging from 2500 cps to 4500 cps. The viscosity less than 2500 cps is too low, so that the adhesive material may not firmly bond the surface sheet and the backing sheet. In contrast, when the viscosity of the adhesive material is more than 4500 cps it may be too high, so that, in the case of shaping and working the bonded steel plate, part of the cured adhesive resin layer may be fractured, or the surface sheet of the bonded steel plate may be warped. Thus, the adhesive material used for the bonded steel plate of the present invention should maintain the viscosity at a substantially predetermined level in order to guarantee excellent formability. Further, due to such viscosity, the adhesive material can further increase sound-absorbing and heat-insulating effects.

Preferably, the surface sheet 10a, 20a is formed to have a thickness ranging from 0.1 mm to 0.5 mm, the backing sheet 10c, 20c is formed to have a thickness from ranging 0.5 mm to 1.9 mm, and the adhesive material 10b, 20b bonding the surface sheet with the backing sheet is formed to have a thickness ranging from 0.02 mm to 0.1 mm. In order to solve the problem that the cost of production sharply increases in the case of using the conventional single steel sheet made of relatively expensive stainless steel and etc., the present invention is technically characterized in that the surface sheet exposed to the outside is formed thin, the backing sheet inside the surface sheet is formed of the relatively inexpensive steel sheet with a suitable thickness, and the adhesive material having excellent sound-absorbing and vibration-damping properties is used to bond the surface sheet and the backing sheet. Preferably, the surface sheet is formed to have a thickness ranging from 0.1 mm to 0.5 mm. When the surface sheet has a thickness 0.1 mm or less, it may be too thin, and thus itself is warped or torn by impact applied from the outside. In contrast, when the surface sheet has a thickness 0.5 mm or more, the effect of reducing the cost of production relatively decreases. Meanwhile, the adhesive material 10b, 20b is formed to have a thickness ranging from 0.02 mm to 0.1 mm. When the adhesive material has a thickness 0.02 mm or less, the sound-absorbing properties may be lowered. In contrast, when the adhesive material has a thickness 0.1 mm or more, the adhesive layer may not maintain uniform viscosity in the thickness direction.

The adhesive material used in the inner and outer plates of the fire door of the present invention is made of a composition that is relatively harmless to the respiratory organs of people when burned so that the fire door of the present invention can minimize casualties at the outbreak of fire while preventing the spread of fire. That is, the adhesive material 10b, 20b is composed of 44% to 46% by weight of ethyl acetate, 40% to 42% by weight of vinyl acetate/acryl copolymer, 8% to 10% by weight of isopropyl alcohol, 1% to 3% by weight of toluene, up to 3% by weight of vinyl acetate and up to 0.1% by weight of acetaldehyde in order to minimize the generation of toxic gas from the chemical substances of the resin material when they are burned. By repeating experiments for a long time, the inventors have developed the adhesive composition, which does not generate toxic gases when burned while having fine sound-absorbing and bonding properties. Thus, applying the developed adhesive composition to the fire door of this invention acts to prevent the spread of fire.

The adhesive layers 25 applied to the opposing surfaces of the inner and outer plates 10 and 20 act to bond the inner and outer plates to the reinforcing brackets 30a and 30b, which are arranged along the vertical edge portions of the inner and outer plates 10 and 20, and the sound absorbing material 40, which are filled between the inner and outer plates and the reinforcing brackets. Preferably, the adhesive layer 25 is made of a foamed urethane. That is, the foamed urethane applied to the inner and outer plates is activated by a hot press machine, thereby reinforcing the bonding force for the reinforcing brackets and the sound-absorbing material attached between the inner and outer plates. Furthermore, the foamed urethane itself, which is foamed inside the hot press machine, can produce both a sound-absorbing effect and a heat-insulating effect.

The pair of the reinforcing brackets 30a and 30b are vertically attached to the vertical edge portions of the inner and outer plates along the vertical direction of the fire door. The reinforcing brackets, which are arranged between and reinforcing the inner and outer plates, function to maintain the shape of the fire door as well as prevent the fire door from warping by external impacts. Also, the sound-absorbing material, filled in the space defined by the inner and outer plates and the reinforcing brackets, absorbs external noise to ensure quietness inside a room as well as obtains heat-insulating effect. Preferably, the sound-absorbing material 40 is made of a honeycomb core or a urethane foam.

As shown in FIGS. 2 and 3, a door frame 50 can be shaped by bending the bonded steel plate used for the inner and outer plates of the present invention. The structure of the bonding steel sheet used for the door frame 50 is the same as that of the bonding steel sheet used for the inner and outer plates of the fire door, and thus detailed description thereof will be omitted. As shown in FIG. 2, a reinforcing plate 52 can be attached to inner portions of the bent door frame 50 using adhesive 54 in order to enhance the stability of the door frame 50.

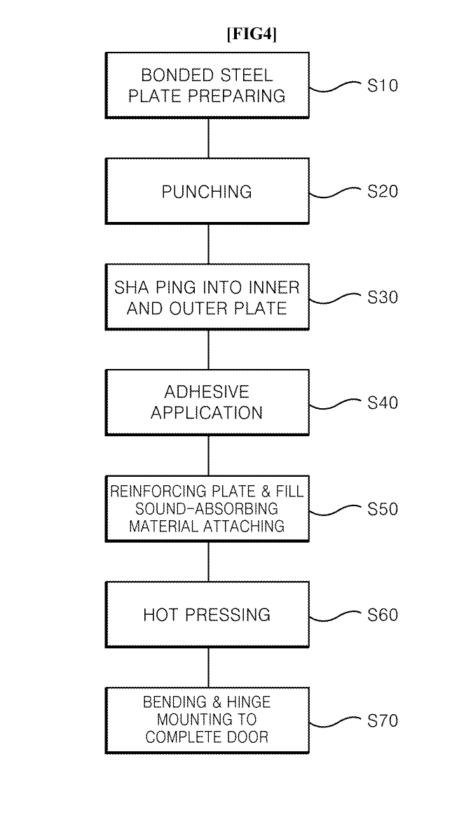

FIG. 4 is a flowchart illustrating a process of manufacturing the fire door according to an embodiment of the present invention.

Referring to FIG. 4, the process of manufacturing the fire door according to the present invention includes steps of: preparing bonded steel plates each of which includes a surface sheet to be exposed on top of the inner or outer side of a fire door, a backing sheet supporting the surface sheet, and an adhesive material interposed between the surface sheet and the backing sheet to bond the surface sheet and the backing sheet together in S10, punching the bonded steel plates so that hinges 2 and a lock device 1 can be mounted thereon in S20, shaping the punched bonded steel plates into an inner plate and an outer plate, which form the inner and outer sides of the fire door in S30, applying an adhesive to opposing inner surfaces of the inner and outer plates in S40, attaching a pair of reinforcing brackets to vertical edge portions of the inner and outer plates along the vertical direction of the fire door and filling a sound-absorbing material between the inner and outer plates and the reinforcing brackets in S50, activating the adhesive using a hot press machine to enhance the bonding force of the reinforcing brackets and the sound-absorbing material arranged between the inner and outer plates in S60, and bending outer vertical peripheries of the inner and outer plates into the shape of the fire door and attaching the hinges and the lock device to holes formed in the inner and outer plates via the punching in S70.

S10 is a step of bonding the surface sheet and the backing sheet together using the adhesive material to prepare the bonded steel plates. In S20, holes where the hinges 2 and the lock device 1 can be mounted are formed, via the punching, in the bonded steel plates that will form the inner and outer plates of the fire door. The punching can be carried out using press punching or Numerically Controlled Turret (NCT) punching. In S30, the inner and outer plates of the fire door are processed by shaping the punched bonded steel plates. In S40, the adhesive is applied to the opposing inner portions of the inner and outer plates. The adhesive acts to enhance the bonding force of the reinforcing brackets and the sound-absorbing material that will later be attached between the inner and outer plates. In S50, the reinforcing brackets are attached between the inner and outer plates to maintain the shape of the door and prevent the door from warping by external impacts, and the sound-absorbing material is filled between the inner and outer plates and the reinforcing brackets to damp external noise. That is, the reinforcing brackets are attached to the edge portions of the inner and outer plates by the adhesive applied thereto, and the sound-absorbing material such as a honeycomb core or a urethane foam is filled in the space defined by the inner and outer plates and the reinforcing brackets attached to the inner and outer plates. In S60, the fire door with the reinforcing brackets and the sound-absorbing material attached thereto is heated and pressed inside the hot press machine, so that the adhesive is activated to enhance the bonding force of the reinforcing brackets and the sound-absorbing material attached between the inner and outer plates. At the same time, the sound-absorbing material such as a urethane is foamed by heating inside the hot press machine, thereby further obtaining noise-isolating and heat-insulating effects. In S70, a final fire door is produced by bending the outer peripheries of the inner and outer plates into the shape of the final fire door and mounting the hinges and the lock devices to the punched holes. Preferably, exposed outer surfaces of the fire door can be processed or surface-treated in order to produce various atmospheres according to the use of the fire door. The outer surfaces of the fire door can be decorated with various colors and patterns using, for example, powder painting and interior films, thereby smoothing the cold feeling and tensed atmosphere of the steel plates of the fire door.

The present invention as set forth above has following advantageous effects. First, since the bonded steel plates with the surface and backing sheets bonded by the adhesive layer are used for the inner and outer plates of the fire door, it is possible to obtain a sound-absorbing function from the adhesive layer of the bonded steel plates, remarkably reduce manufacturing cost, ensure fine aesthetic appearance and a fireproof performance equal to those of conventional fire doors, and in combination, to achieve excellent noise-isolating and sound-absorbing effects.

Second, since each adhesive layer of the bonded steel plates of the present invention is adapted to maintain proper viscosity, the adhesive layer is not fractured when the inner and outer plates are manufactured by bending the bonded steel plates and the viscosity of the adhesive layer can enhance sound-absorbing property.

Third, in order to overcome the problem of sharp increase in manufacturing cost due to the use of a single steel plate, which is made of a relatively expensive material such as copper and aluminum, the present invention forms the thinner surface sheets, which are exposed to the outside of the fire door, using a steel sheet having excellent aesthetic appearance and processability, forms the thicker backing sheets, which are arranged inside to support the surface sheets, using a relatively cheaper steel plate, and bonds the surface and backing sheets together using the adhesive excellent in sound-absorbing property, thereby remarkably reducing the manufacturing cost.

Fourth, the present invention can prevent casualties caused by gases produced from burning adhesive at the outbreak of fire, by adopting a composition, which does not generate toxic gases when burned, as the adhesive for bonding the surface and backing sheets.

Fifth, the present invention can be variously applied, particularly, to a front door or an outside equipment door, which is generally made of iron or steel in the prior art, and to a bedroom door by finishing surface sheets, which can be excellently decorated, with powder painting or interior films in order to replace interior doors that are very vulnerable to fire.

Sixth, the present invention can reduce the weight of the door by manufacturing the backing sheets, which are not exposed to the outside, with an inexpensive and light material. In particular, the door of the present invention can be applied to a bedroom door and so on, which should be easily opened and closed.

Although the exemplary embodiments of the present invention have been described for illustrative purposes, those skilled in the art will appreciate that various modifications, additions and substitutions are possible, without departing from the scope and spirit of the invention as defined in the accompanying claims.

1. A fire door comprising:
an inner plate forming an inner side of the fire door;
an outer plate opposing the inner plate to form an outer side of the fire door;
adhesive layers applied respectively to opposing surfaces of the inner and outer plates;
a pair of reinforcing brackets vertically attached respectively to opposite edge portions of and between both of the inner and outer plates; and a sound absorbing material filled in a space defined by the inner and outer plates and the reinforcing brackets,
wherein each of the inner and outer plates comprises a bonded steel plate, which includes a surface sheet exposed to the inner or outer side of the fire door, a backing sheet supporting the surface sheet, and an adhesive material interposed between the surface sheet and the backing sheet and bonding the surface sheet and the backing sheet together, whereby the fire door has excellent sound absorbing and fireproof properties.

2. The fire door according to claim 1, wherein the adhesive layers comprise foamed urethane, and the sound absorbing material comprises a honeycomb core or a urethane foam.

3. The fire door according to claim 1, wherein each of the adhesive materials has a thickness ranging from 0.02 mm to 0.1 mm.

4. The fire door according to claim 1, wherein each of the surface sheets has a thickness ranging from 0.1 mm to 0.5 mm, and each of the backing sheets has a thickness ranging from 0.5 mm to 1.9 mm.

5. The fire door according to claim 1, wherein each of the surface sheets and the backing sheets has a bending rigidity ranging from 10.5 Nm to 16.5 Nm.

6. The fire door according to claim 1, wherein the adhesive materials have a viscosity ranging from 2500 cps to 4500 cps.

7. The fire door according to claim 1, wherein the adhesive materials comprise 44% to 46% by weight of ethyl acetate, 40% to 42% by weight of vinyl acetate/acryl copolymer, 8% to 10% by weight of isopropyl alcohol, 1% to 3% by weight of toluene, up to 3% by weight of vinyl acetate and up to 0.1% by weight of acetaldehyde.

8. The fire door according to claim 1, wherein the surface sheets comprise one selected from a group consisting of stainless steel, aluminum and copper, which are excellent in surface treatment and surface processing, and wherein the backing sheets comprise one selected from a group consisting of a zinc-coated steel sheet, a stainless steel sheet, an aluminum sheet, a pre-painted steel sheet, a cold-rolled steel sheet and a pickled and oiled steel sheet.

9. A fire door manufacturing method, comprising:
preparing a bonded steel plate, which includes a surface sheet to be exposed to the inner or outer side of a door, a backing sheet supporting the surface sheet, and an adhesive layer interposed between the surface sheet and the backing sheet to bond the surface sheet and the backing sheet together;
punching the bonded steel plate so that hinges and a lock device can be mounted thereon;
shaping the punched bonded steel plate into an inner plate and an outer plate, which form the inner and outer sides of the door;
applying an adhesive material to opposing inner surfaces of the inner and outer plates;
attaching a pair of reinforcing brackets to opposite edge portions between the inner and outer plates along the vertical direction of the door and filling a sound-absorbing material in a space defined by the inner and outer plates and the reinforcing brackets;
activating the adhesive material using a hot press machine to enhance the bonding force of the reinforcing brackets and the sound-absorbing material arranged between the inner and outer plates; and
bending outer vertical peripheries of the inner and outer plates into the shape of the door and attaching the hinges and the lock device to holes formed in the inner and outer plates in said punching step.

10. The method according to claim 9, wherein the adhesive material comprises a foamed urethane, wherein the foamed urethane is foamed in said activating step.

11. The method according to claim 9, wherein each of the surface and backing sheets has a bending rigidity ranging from 10.5 Nm to 16.5 Nm.

12. The method according to claim 9, wherein the adhesive material has a viscosity ranging from 2500 cps to 4500 cps.
